(19) United States
(12) Patent Application Publication
(10) Pub. No.: US 2022/0141716 A1
(43) Pub. Date: May 5, 2022

(54) Sidelink Resource Allocation Enhancements

(71) Applicant: MediaTek Singapore Pte. Ltd., Singapore (SG)

(72) Inventors: Tao Chen, Beijing (CN); Lung-Sheng Tsai, Hsinchu City (TW); Guan-Yu Lin, Hsinchu City (TW); Ahmet Umut Ugurlu, Cambridge (GB); Ming-Yuan Cheng, Hsinchu City (TW)

(21) Appl. No.: 17/501,284

(22) Filed: Oct. 14, 2021

(30) Foreign Application Priority Data
Oct. 29, 2020 (CN) PCT/CN2020/124858
Sep. 23, 2021 (CN) 202111114570.X

(51) Int. Cl. H04W 28/26; H04W 72/04; H04W 72/10

(52) U.S. Cl. CPC H04W 28/26; H04W 72/10; H04W 72/0446; H04W 72/0406

(57) ABSTRACT

Various examples and schemes pertaining to sidelink (SL) resource allocation enhancements in New Radio (NR) vehicle-to-everything (V2X) communications are described. A user equipment (UE) receives a first sidelink control information (SCI) carrying first assistance information indicating one or more reserved resources. The UE determines a disposition with respect to the first assistance information. In response to the disposition with respect to the first assistance information, the UE transmits a second SCI carrying second assistance information related to the first assistance information.

### CROSS REFERENCE TO RELATED PATENT APPLICATION(S)

The present disclosure claims the priority benefit of China Patent Application No. 202111114570.X, filed 23 Sep. 2021, which is part of a China national stage application of PCT Application No. PCT/CN2020/124858, filed 29 Oct. 2020. Contents of aforementioned applications are herein incorporate by reference in their entirety.

### TECHNICAL FIELD

The present disclosure is generally related to wireless communications and, more particularly, to sidelink (SL) resource allocation enhancements.

### BACKGROUND

Unless otherwise indicated herein, approaches described in this section are not prior art to the claims listed below and are not admitted as prior art by inclusion in this section.

Under the 3^{rd} Generation Partnership Project (3GPP) specification for 5th Generation (5G) New Radio (NR), vehicle-to-everything (V2X) SL communications can be supported by unicast, groupcast and broadcast communications. However, there remain certain issues that need to be addressed with respect to SL resource allocation to improve reliability and reduce latency in SL communications. Therefore, there is a need for a solution of SL resource allocation enhancements.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

One objective of the present disclosure is to propose various schemes, concepts, designs, methods, systems and apparatuses pertaining to SL resource allocation enhancements. It is believed that various schemes proposed herein may improve reliability and reduce latency to address certain issues in 5G NR V2X communications.

For instance, regarding SL resource allocation, a user equipment (UE) may transmit or otherwise forward assistance information, including resource reservation information, received from one or more other UEs. To avoid the issue of resource overbooking, a cancellation mechanism for reserved but unused resources may be utilized. For partial sensing-based resource allocation, the UE may perform sensing before or after packet arrival, depending on the traffic type, to address the issue of aperiodic transmission interference. For SL discontinuous reception (DRX), the UE may transmit its receive (Rx) pattern and/or transmit (Tx) pattern so that other UEs with a lower priority may follow the UE. Similarly, when the UE receives multiple Rx and/or Tx patterns from one or more other UEs, the UE may determine whether to combine the received patterns (supposition) with its own pattern according to the UE's own priority and the priorities of the one or more other UEs which are (pre-)configured or indicated in sidelink control information (SCI).

In one aspect, a method may involve receiving a first SCI carrying first assistance information indicating one or more reserved resources. The method may also involve determining a disposition with respect to the first assistance information. The method may further involve transmitting a second SCI carrying second assistance information related to the first assistance information responsive to the disposition with respect to the first assistance information.

In another aspect, a method may involve receiving, from a UE, a first SCI carrying first resource reservation information indicating one or more reserved resources as being reserved. The method may also involve receiving, from the first UE, a cancellation SCI carrying information of at least one of the one or more reserved resources. The method may further involve marking the at least one of the one or more resources as being available for utilization.

In yet another aspect, a method may involve receiving a pattern of Tx or Rx via an SL from a UE. The method may also involve determining whether to follow the received pattern or to combine the received pattern with one or more existing Tx/Rx patterns. The method may further involve performing Tx and Rx when DRX is in effect based on a result of the determining.

It is noteworthy that, although description provided herein may be in the context of certain radio access technologies, networks and network topologies such as 5G/NR V2X, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Wireless Fidelity (Wi-Fi) and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario under a proposed scheme in accordance with the present disclosure.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a block diagram of an example communication environment in which various proposed schemes in accordance with the present disclosure may be implemented.

FIG. 7 is a flowchart of an example process under a proposed scheme in accordance with an implementation of the present disclosure.

FIG. 8 is a flowchart of an example process under a proposed scheme in accordance with an implementation of the present disclosure.

FIG. 9 is a flowchart of an example process under a proposed scheme in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to SL resource allocation enhancements in NR V2X communications. According to the present disclosure, a number of possible solutions or schemes may be implemented separately or jointly. That is, although these possible solutions/schemes may be described below separately, two or more of these possible solutions/schemes may be implemented in one combination or another.

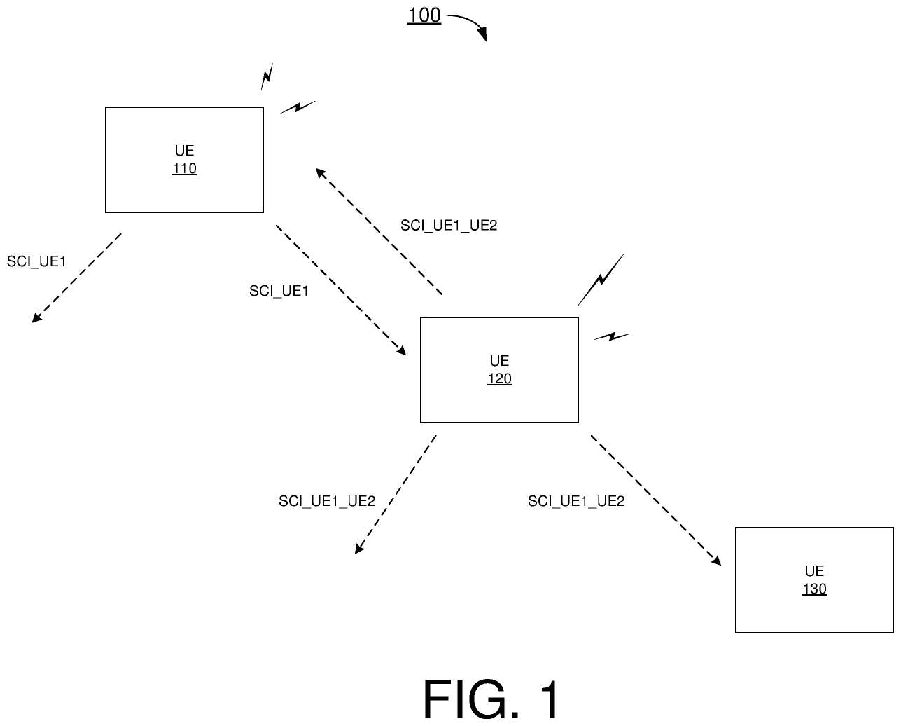

FIG. 1 illustrates an example network environment 100 in which various solutions and schemes in accordance with the present disclosure may be implemented. Referring to FIG. 1, network environment 100 may involve a UE 110 (herein interchangeably referred to as “UE1”), UE 120 (herein interchangeably referred to as “UE2”) and UE 130 (herein interchangeably referred to as “UE3”) in wireless communication in an NR V2X network. In network environment 100, UE 110, UE 120 and UE 130 may implement various schemes pertaining to SL resource allocation enhancements in accordance with the present disclosure, as described below.

Under a proposed scheme in accordance with the present disclosure regarding SL resource allocation, a UE (e.g., UE2) may transmit or otherwise forward assistance information received from another UE (e.g., UE1). That is, UE2 may receive from UE1 a first SCI (herein interchangeably referred to as “SCI_UE1”) and the, correspondingly, transmit a second SCI ((herein interchangeably referred to as “SCI_UE1_UE2”) to UE3 under various proposed schemes in accordance with the present disclosure. Thus, UE1 may herein be denoted as an “assisted UE” while UE2 may herein be denoted as an “assisting UE” since UE2 assists UE1 in forwarding or otherwise promulgating the assistance information to UE3 from UE1 which is being assisted. The assistance information in SCI_UE1 transmitted by UE1 may include resource reservation information regarding time/frequency resources reserved by UE1, which may be utilized by UE2 and/or UE3 in selecting time/frequency resources in respective transmissions in order to avoid collision in transmission and/or overlap in resource reservation/usage. In case that all time/frequency resources indicated in the assistance information are valid (e.g., not yet expired at the time UE2 receives the assistance information from UE1), reserved frequency resources indicated in the assistance information in SCI_UE1_UE2 transmitted by UE2 may be same as that indicated in SCI_UE1 received from UE1.

On the other hand, under the proposed scheme, reserved time resources indicated in the assistance information in SCI_UE1 may be updated by UE2 (before being transmitted or otherwise forwarded in SCI_UE1_UE2) according to the transmission time of the assistance information in SCI_UE1_UE2 rather than being the same as indicated in SCI_UE1 from UE1. This is because a “time resource assignment” field in SCI_UE1 indicates time slot(s) of reserved resource(s) by slot offset(s) relative to the time of transmission of SCI_UE1 rather than the time of transmission of SCI_UE1_UE2. In other words, the reference timing used in the slot offset(s) may be changed as the time of transmission of SCI_UE1 and the time of transmission of SCI_UE1_UE2 are different.

As an illustrative and non-limiting example, it may be assumed that time slot locations of reserved time resources indicated in SCI_UE1 from UE1 are (t0′, t1′, t2′) for three (denoted by N=3) reserved resources, with t0′ being the time slot where the first SCI occupies. Accordingly, the “time resource assignment” field, which is defined in SCI format 1-A, carries time slot offset information of t1=t1′−t0′ and t2=t2′−t0′ for the reserved resources and also information on the number of reserved resources (N), in the form of time reservation indicator value (TRIV). In forwarding the assistance information contained in SCI_UE1, which is sent in time slot tn, UE2 needs to update the “time resource assignment” field so that the “time resource assignment” field implies t1=t1′−tn′ and t2=t2′−tn′ in case of tn<t1′ in the forwarded assistance information. However, in case of t1′<tn<t2′, it would be too late to forward resource reservation information of the second reserved resource, then N may be reduced to 2. In such a case, the frequency reservation indicator value (FRIV) field defined for SCI format 1-A is reused to represent reserved frequency resources in the assistance information, the FRIV in the forwarded SCI_UE1 (which is included in SCI_UE1_UE2 transmitted by UE2) also needs to be updated. For example, the FRIV may be updated by UE2 assigning a starting sub-channel index for the third resource to the value of a starting sub-channel index for the second resource. Because it is set that N=2, the starting sub-channel index for the third resource is automatically not used. Such reserved resource information may be carried in SCI of SL transmission, e.g., the first SCI of a two-stage SCI by reusing the corresponding fields of SCI_UE1 from UE1. Thus, the resource reservation information carried in the assistance information from UE2 may be different than the one in the assistance information from UE1. The time resources associated with the frequency resources may be expired before the transmission of the assistance information and, in such cases, the time/frequency resource information in the assistance information may be removed. In other words, the time/frequency resource information may be updated for each assistance information transmission according to the transmission time.

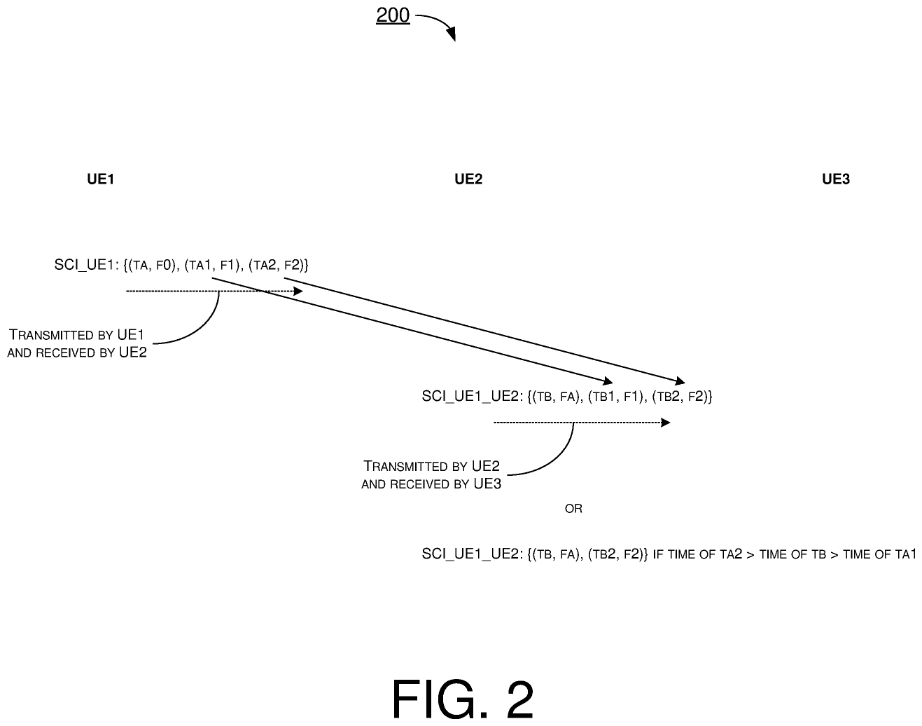

FIG. 2 illustrates an example scenario 200 under a proposed scheme with respect to SCI forwarding timing in accordance with the present disclosure. Referring to FIG. 2, initially in scenario 200, UE1 transmits a first SCI (denoted as “SCI_UE1” in FIG. 2) at time tₐ and frequency f₀ with assistance information including resource reservation information that indicates the reservation of time and frequency resources at time tₐ₁ at frequency f₁ and at time tₐ₂ at frequency f₂, with times tₐ₁ and tₐ₂ being relative to (offset from) time tₐ. Upon receiving SCI_UE1, UE2 may forward the assistance information carried in SCI_UE1 by transmitting a second SCI (denoted as “SCI_UE1_UE2” in FIG. 2) at time t_{b} and frequency fa with assistance information including resource reservation information that indicates the reservation of time and frequency resources at time t_{b1} at frequency f₁ and at time t_{b2} at frequency f₂, with times t_{b1} and t_{b2} being relative to (offset from) time t_{b}. As mentioned above, given that the time of transmission of the second SCI (at time t_{b}) is different from (e.g., later than) the time of transmission of the first SCI (at time tₐ), the reference timing is changed (that is, the second SCI indicates a second reference timing which is different from a first reference timing indicated in the first SCI) and thus the respective timing offsets need to be changed from tₐ₁ and tₐ₂ to t_{b1} and t_{b2}, respectively. It is noteworthy that, in an event that the transmission time t_{b} of SCI_UE1_UE2 is later than any resource indicated in the assistance information (e.g., tₐ₁), then such resource may be excluded from the forwarded assistance information. For instance, in case that t_{b} is after tₐ₁ (e.g., t_{b}>tₐ₁) then the assistance information carried in SCI_UE1_UE2 would not indicate the time and frequency resources at time tₐ₁ at frequency f₁.

Under the proposed scheme, considering the processing time at the other UEs to perform the resource (re-)selection according to the assistance information, the updates or a decision as to whether to transmit the reserved resources may further take into account both the transmission time of the assistance information and the processing time at the other UEs. For instance, in case that all time resources with the associated frequency resources indicated in the SCI from the assisted UE (e.g., SCI_UE1 from UE1) are earlier than the (selected) transmission time of assistance information, the transmission of the corresponding assistance information in SCI_UE1_UE2 may be cancelled since it would be obsolete. In other words, the packet delay budget (PDB) of the assistance information may be set or derived according to the time of the (earliest) reserved time/frequency resources in a resource list of the assistance information (e.g., by excluding the processing time at the other UE(s)).

Under a proposed scheme in accordance with the present disclosure, the assisting UE (e.g., UE2) may change (e.g., add or remove) some reserved resources in the corresponding fields if necessary. For example, the assisting UE may set a resource reservation period to zero in forwarding SCI_UE1 in the SCI_UE1_UE2. The assisting UE may also add its own resource reservation information on top of that from the assisted UE. One indicator in SCI signal (e.g., first SCI, second SCI, or a new format indicator for the second SCI in the first SCI) may be utilized to indicate or otherwise imply whether that particular SCI signaling is carrying assistance information or is associated with a physical sidelink shared channel (PSSCH) carrying the assistance information.

Under a proposed scheme in accordance with the present disclosure, a source identifier (herein denoted as “source ID” and “srcID”) and/or a destination identifier (herein denoted as “destination ID” and “destID”) carried in the SCI(s) associated with the assistance information transmitted by the assisting UE (e.g., UE2) may be the same as the one(s) carried in the second SCI from one or more other UEs. Additionally, a hop number for transmission of the assistance information may be indicated in first SCI or the second SCI. The total number of hops for assistance information transmission may be (pre-)configured or indicated in SCI (e.g., the second SCI), for example, in terms of per resource pool or per bandwidth part. Under the proposed scheme, to ensure that the assisted UE can detect the source ID in the assistance information correctly, at least a portion of the source ID (e.g., 4 bits) may be carried (or duplicated) in the first SCI.

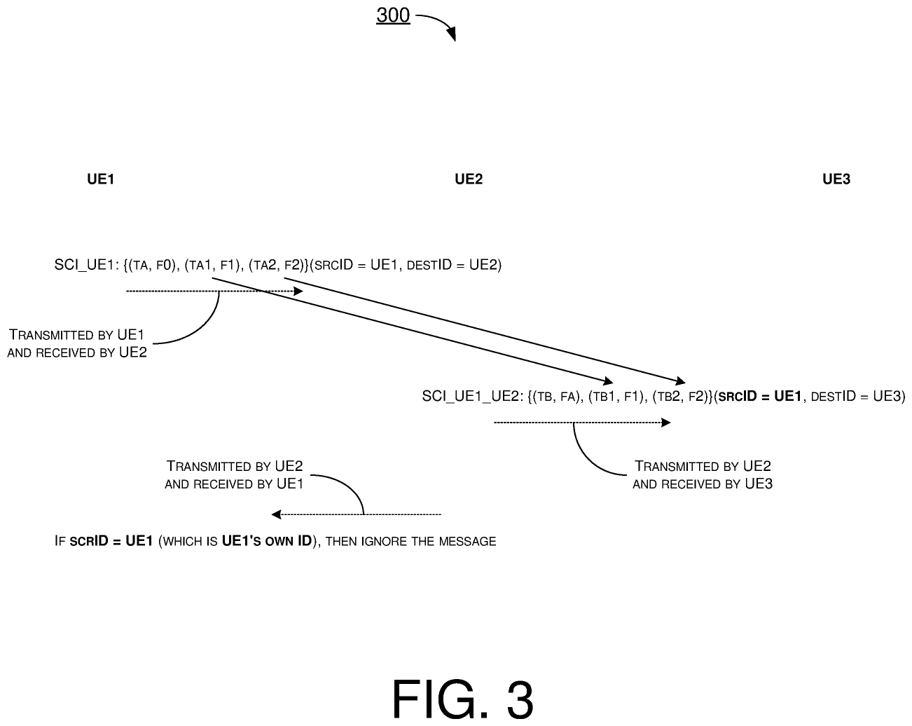

FIG. 3 illustrates an example scenario 300 under a proposed scheme with respect to SCI forwarding ID setting in accordance with the present disclosure. Referring to FIG. 3, initially in scenario 300, UE1 transmits a first SCI (denoted as “SCI_UE1” in FIG. 3) with a source ID being “UE1” and a destination ID being “UE2” to indicate that the first SCI is transmitted from UE1 with an intended target or receiver being UE2. When UE2 transmits a second SCI (denoted as “SCI_UE1_UE2” in FIG. 3), UE2 may change the destination ID to “UE3” while leaving the source ID unchanged as “UE1” so as to indicate that UE3 is the intended target or receiver of the second SCI. This may also allow UE1, upon receiving the second SCI, to discern that the assistance information carried in the second SCI being originated from UE1 itself and, thus, UE1 may ignore the message carried by the second SCI.

Under a proposed scheme in accordance with the present disclosure, one indicator (herein denoted as a “format indicator”) in the first SCI and/or the second SCI may be utilized to indicate or otherwise imply whether a UE is supporting such a new mechanism (e.g., whether the UE is capable of transmitting and/or receiving such assistance information). Accordingly, an assisting UE (e.g., UE2) transmitting the assistance information may check whether the assisted UE (e.g., UE1) is capable of the assistance information reception. If not supported by the assisted UE, the assisting UE may restrict the transmission power or skip assistance information transmission to avoid any confusing or mistake at the assisted UE. Because the assisted UE (e.g., a legacy UE) may not differentiate whether the received SCI/data is an assistance information carrying its own reservation/information with no need of channel sensing or an normal SCI/data transmission with the need of channel sensing. In case that the assisted UE supports reception of the assistance information, the assisted UE may indicate such capability via signaling (e.g., via radio resource control (RRC), PC5-RRC or an indicator in SCI). Then, the assisting UE may transmit the assistance information by setting the assistance information indicator and the proper source (and/or destination) UE ID (e.g., the assisted UE ID) in SCI (e.g., SCI_UE1_UE2). Upon reception of the assistance information, the assisted UE may know that the received information is an assistance information according to the indicator and may further know that the received SCI is carrying the assisted UE's own related information by finding the source ID to be the same as its own ID. Therefore, the assisted UE (e.g., UE1) may skip channel sensing (e.g., skip reference signal received power (RSRP) measurements on a channel) on this assistance information which is intended for one or more other UEs (e.g., UE3) to avoid causing interference. This may avoid mistakes in resource (re-)selection at the assisted UE.

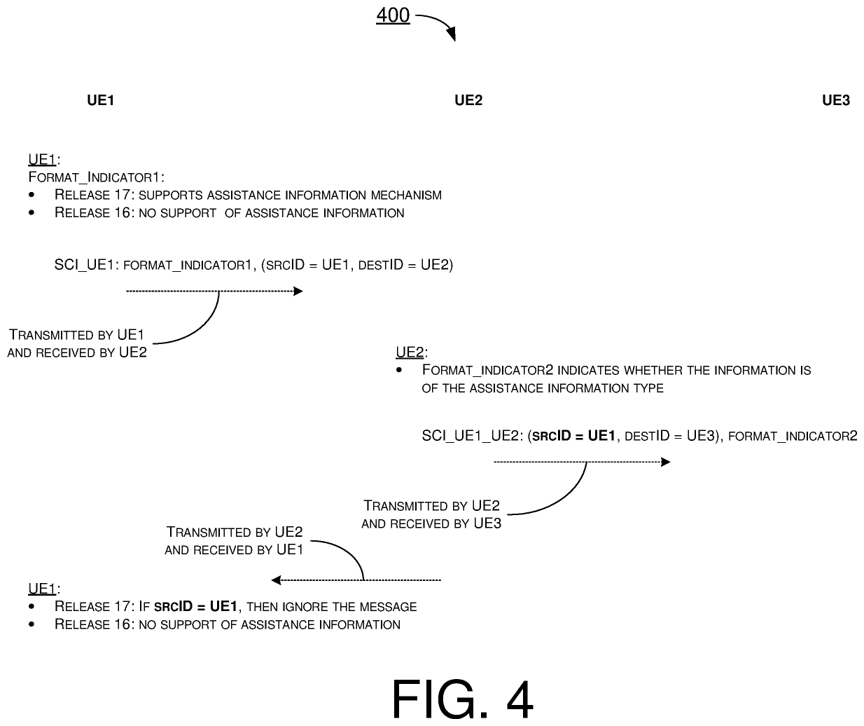

FIG. 4 illustrates an example scenario 400 under a proposed scheme with respect to utilization of a format indicator in SCI in accordance with the present disclosure. Referring to FIG. 4, in scenario 400, in case that UE1 supports Release 17 (Rel-17) of the 3GPP specification for NR, UE1 may set a format indicator (denoted as “format_indicator1” in FIG. 4) to indicate its support of the assistance information mechanism described herein when UE1 transmits a first SCI (denoted as “SCI_UE1” in FIG. 4). Otherwise, in case UE1 is a legacy UE that supports Release 16 (Rel-16) of the 3GPP specification for NR, UE1 may not support the assistance information mechanism and, thus, there may be no such format indicator in the first SCI. Similarly, when UE2 transmits the second SCI (denoted as “SCI_UE1_UE2” in FIG. 4), UE2 may set a format indicator (denoted as “format_indicator2” in FIG. 4) to indicate that the type of the information carried in the second SCI is the assistance information type. Upon receiving the second SCI, in case that UE1 supports Release 17 of the 3GPP specification for NR, UE1 may ignore the second SCI.

Under a proposed scheme in accordance with the present disclosure, a multi-hop forwarding mechanism may be supported. Under the proposed scheme, each potential assisting UE may check a maximum allowed hopping number ((pre-)configured or indicated in SCI, e.g., in the second SCI) and the current hop number indicated in a given SCI. In an event that the current hop number is smaller than the maximum allowed hop number, the UE may promote itself as an assisting UE to transmit the assistance information and, additionally, increment the hop number based on the one indicated in the received SCI by 1. Additionally, the received RSRP level, the priorities, and the UE power level may be used jointly by a UE to determine whether it can be promoted as an assisting UE.

Under a proposed scheme in accordance with the present disclosure, when one or more other UE(s) receive the SCI carrying/associated with the assistance information, the one or more other UE(s) may perform RSRP measurement on the physical sidelink control channel-demodulation reference signal (PSCCH-DMRS) (and/or PSSCH-DMRS in case the second SCI and/or PSSCH is associated with the first SCI) according to (pre-)configuration or a pre-defined rule. Each UE of the one or more other UE(s) may, according to the priority indicated in the first SCI, a transmission priority of the respective UE, the measurement RSRP results, and the reserved resources indicated in SCI (e.g., the first SCI), determine whether it can use the corresponding resource(s) for transmission or perform resource (re-)selection.

Under a proposed scheme in accordance with the present disclosure, to transmit assistance information carried in SCI signaling (e.g., the first SCI and/or the second SCI), dummy data may be generated so that a resource (re-)selection procedure may be applied for resource allocation. Alternatively, a standalone SCI transmission without PSSCH carrying the dummy data may be applied. In this case, the resource(s) for assistance information transmission may be (pre-)configured per resource pool or derived from a rule, e.g., a function of the UE ID(s) such as the ID of the assisted UE (e.g., UE1), the assisting UE (e.g., UE2) and/or the target receiver UE (e.g., UE3). The resource(s) for assistance information may also be reserved by the assisted UE expecting the assistance information transmission by the assisting UE. Under the proposed scheme, the ID of the assisted UE and/or the assisting UE may be used to determine the resource(s) for the assistance information in a resource set or region (pre-)configured in a resource pool for assistance information (or standalone SCI) transmission. In this case, the assisting UE may derive the resource location (or the starting location) within the resource set (or region/pool) comprising a number of resources by modulus operation. For instance, the following expression may be used in determining the resource location: resource location=Mod (the assisted UE ID, the number of resources in the region). Alternatively, the following expression may be used in determining the resource location: resource location=Mod (the assisted UE ID+the assisting UE ID, the number of resources in the region). Alternatively, the following expression may be used in determining the resource location: resource location=Mod (the assisting UE ID, the number of resources in the region).

Under a proposed scheme in accordance with the present disclosure, to address the issue of overbooking for periodic and/or aperiodic reservations, a cancellation mechanism for those reserved but unused resources may be utilized. Under the proposed scheme, a new format of SCI (with the same SCI size) with a format indicator for cancellation purpose or a cancellation indicator in the existing SCI(s) may be used to indicate that a given SCI is a cancellation SCI. The cancellation SCI (e.g., the first SCI) may carry information of the resources to be cancelled by (re-)using a field for resource reservation in (the first) SCI (either periodic or aperiodic reservation). The cancellation SCI may be transmitted on one or more of the reserved resources following a resource (re-)selection procedure, the (pre-)configured/derived resource(s), and/or the resource(s) reserved by the previous (overbooking) SCI. Upon reception of the cancellation SCI on one or more of the resources reserved in a previously received SCI, a sensing UE (e.g., UE2 or UE3) may mark/update the corresponding resources as being available regardless of any previous channel sensing results. Alternatively, or additionally, the sensing UE may compare the source ID in the cancellation SCI with a stored UE ID for the corresponding resources to determine whether the corresponding channel sensing results should be removed in case of multiple channel sensing results for the same resources used by multiple UEs.

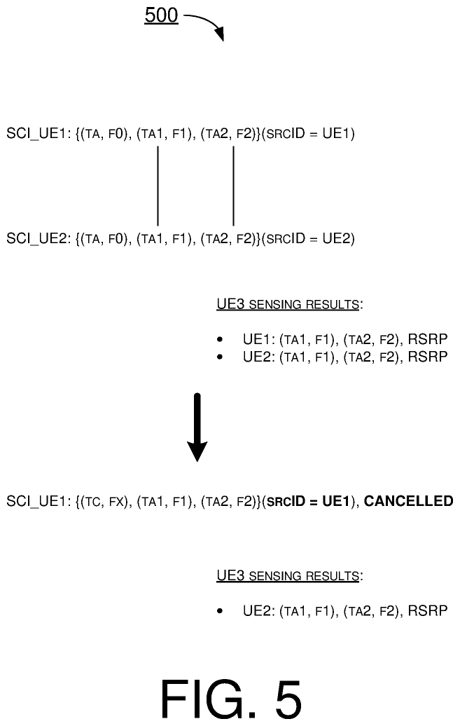

FIG. 5 illustrates an example scenario 500 under a proposed scheme with respect to cancellation of resource reservation in accordance with the present disclosure. Referring to FIG. 5, in scenario 500, UE1 may transmit an SCI (denoted as “SCI_UE1”) with assistance information including resource reservation information that indicates the reservation of time and frequency resources at time tₐ₁ at frequency f₁ and at time tₐ₂ at frequency f₂, and UE2 may transmit another SCI (denoted as “SCI_UE2”) with assistance information including resource reservation information that indicates the reservation of time and frequency resources at time tₐ₁ at frequency f₁ and at time tₐ₂ at frequency f₂. The SCI_UE1 transmitted by UE1 may indicate a source ID of “UE1” and the SCI_UE2 transmitted by UE2 may indicate a source ID of “UE2”. Accordingly, the channel sensing results obtained by UE3 may include, for example, (tₐ₁, f₁), (tₐ₂, f₂) and a respective RSRP for UE1 as well as (tₐ₁, f₁), (tₐ₂, f₂) and a respective RSRP for UE2. Subsequently, UE1 may transmit a cancellation SCI that indicates the reserved resources (tₐ₁, f₁), (tₐ₂, f₂), the source ID of “UE1”, and an indication that this SCI is a cancellation SCI. Thus, upon receiving the cancellation SCI, UE3 may compare the source ID indicated in the cancellation SCI with stored UE IDs (e.g., UE1 and UE2) for corresponding resources (e.g., (tₐ₁, f₁), (tₐ₂, f₂)) to determine that the channel sensing result corresponding to UE1 is to be removed. It is noteworthy that, in scenario 500, given that the same resources are also indicated as being reserved in the SCI transmitted by UE2, the removal of the channel sensing result corresponding to UE1 does not necessarily mean that those resources reserved in the SCI previously transmitted by UE1 are available for UE3 (since they are still reserved by UE2). In such a case, in an event that the sensed RSRP of UE2 is strong, then UE3 may not use those resources. On the other hand, in an event that the sensed RSRP of UE2 is rather weak, then UE3 may be able to use those resources.

Under a proposed scheme in accordance with the present disclosure, for a partial sensing-based resource allocation, the sensing to address aperiodic transmission interference may be performed before or after packet arrival depending on the traffic type. Such traffic type information may be from a higher layer. In an event that the traffic type is a periodic traffic, a UE may perform sensing to address aperiodic transmission interference before the packet arrival since the packet arrival time is known. In this case, a delay budget for resource (re-)selection may not exclude such sensing time. However, in an event that the traffic type is an aperiodic traffic, the UE may perform sensing to address aperiodic transmission interference after the packet arrival since the packet arrival time is unknown. In this case, the delay budget for resource (re-)selection may exclude such sensing time. In addition, the UE may perform periodic sensing to address the issue of periodic transmission interference.

Under a proposed scheme in accordance with the present disclosure, for power saving, a UE may determine and broadcast/unicast its own Tx/Rx patterns in the context of DRX (e.g., Tx/Rx patterns when the UE is implementing DRX). As such, there may be potential collision (misalignment) on Tx/Rx patterns between different UEs or within a single UE (e.g., due to Tx-Rx and/or Tx-Tx collision). In such a case, while one UE may make decision to avoid collision based on its Tx pattern while another UE may make decision to avoid collision based on its Rx pattern, one solution may be to (pre-)configure a resource pool applied with only Rx pattern configuration (and not Tx pattern) so that there would be no collision between Tx/Rx and Tx-Tx patterns. Alternatively, a UE may determine a pattern for DRX based on the priorities (pre-)configured per link pair, per UE, per Tx/Rx pattern, or per packet priority as indicated in SCI signaling. In other words, the UE may determine whether to combine (with one or more existing patterns) or follow a received pattern for DRX according to the corresponding priority associated with the received pattern. In case that the priority associated with the received pattern is higher than its own priority, the UE may follow the received pattern (in addition to any existing pattern) for DRX. Otherwise, in case that the priority associated with the received pattern is lower than its own priority, the UE may reply to a peer UE by signaling its own pattern or preferred pattern associated with the priority information. Then, the peer UE with the lower priority may follow the UE's pattern for transmission or reception according to a decision rule. It is noteworthy that the “priority” described herein may refer to the priority per link pair, per UE, per Tx pattern, per Rx pattern, or per packet priority as indication in SCI.

### Illustrative Implementations

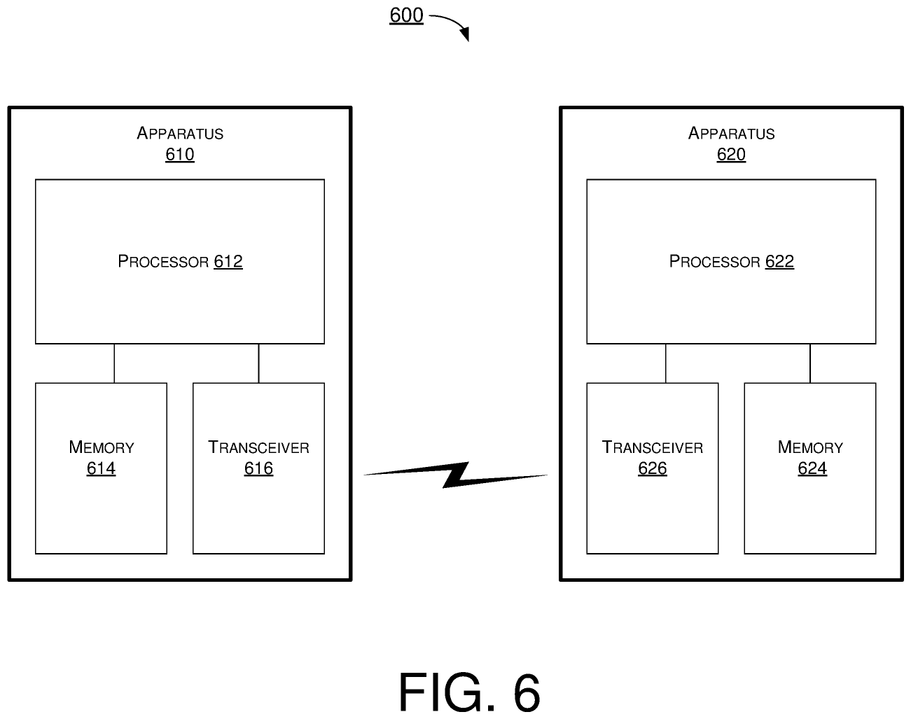

FIG. 6 illustrates an example communication environment 600 having an example apparatus 610 and an example apparatus 620 in accordance with an implementation of the present disclosure. Each of apparatus 610 and apparatus 620 may perform various functions to implement schemes, techniques, processes and methods described herein pertaining to SL resource allocation enhancements in NR V2X communications, including various schemes described herein.

Each of apparatus 610 and apparatus 620 may be a part of an electronic apparatus, which may be a UE such as a vehicle, a portable or mobile apparatus, a wearable apparatus, a wireless communication apparatus or a computing apparatus. For instance, each of apparatus 610 and apparatus 620 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 610 and apparatus 620 may also be a part of a machine type apparatus, which may be an IoT or NB-IoT apparatus such as an immobile or a stationary apparatus, a home apparatus, a wire communication apparatus or a computing apparatus. For instance, each of apparatus 610 and apparatus 620 may be implemented in a smart thermostat, a smart fridge, a smart door lock, a wireless speaker or a home control center. Alternatively, each of apparatus 610 and apparatus 620 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Each of apparatus 610 and apparatus 620 may include at least some of those components shown in FIG. 6 such as a processor 612 and a processor 622, respectively. Each of apparatus 610 and apparatus 620 may further include one or more other components not pertinent to the proposed scheme of the present disclosure (e.g., internal power supply, display device and/or user interface device), and, thus, such component(s) of each of apparatus 610 and apparatus 620 are neither shown in FIG. 6 nor described below in the interest of simplicity and brevity.

In some implementations, at least one of apparatus 610 and apparatus 620 may be a part of an electronic apparatus, which may be a vehicle, a roadside unit (RSU), network node or base station (e.g., eNB, gNB or TRP), a small cell, a router or a gateway. For instance, at least one of apparatus 610 and apparatus 620 may be implemented in a vehicle in a V2V or V2X network, an eNodeB in an LTE, LTE-Advanced or LTE-Advanced Pro network or in a gNB in a 5G, NR, IoT or NB-IoT network. Alternatively, at least one of apparatus 610 and apparatus 620 may be implemented in the form of one or more IC chips such as, for example and without limitation, one or more single-core processors, one or more multi-core processors, one or more RISC processors, or one or more CISC processors.

In one aspect, each of processor 612 and processor 622 may be implemented in the form of one or more single-core processors, one or more multi-core processors, one or more RISC processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including SL resource allocation enhancements in NR V2X communications in accordance with various implementations of the present disclosure.

In some implementations, apparatus 610 may also include a transceiver 616, as a communication device, coupled to processor 612 and capable of wirelessly transmitting and receiving data. In some implementations, apparatus 610 may further include a memory 614 coupled to processor 612 and capable of being accessed by processor 612 and storing data therein. In some implementations, apparatus 620 may also include a transceiver 626, as a communication device, coupled to processor 622 and capable of wirelessly transmitting and receiving data. In some implementations, apparatus 620 may further include a memory 624 coupled to processor 622 and capable of being accessed by processor 622 and storing data therein. Accordingly, apparatus 610 and apparatus 620 may wirelessly communicate with each other via transceiver 616 and transceiver 626, respectively.

To aid better understanding, the following description of the operations, functionalities and capabilities of each of apparatus 610 and apparatus 620 is provided in the context of a NR V2X communication environment in which apparatus 610 is implemented in or as a wireless communication device, a communication apparatus or a first UE (e.g., UE1 in network environment 100) and apparatus 620 as a wireless communication device, a communication apparatus or a second UE (e.g., UE2 in network environment 100).

Under a proposed scheme pertaining to SL resource allocation enhancements in NR V2X communications in accordance with the present disclosure, processor 622 of apparatus 620 may receive, via transceiver 626, a first SCI carrying first assistance information indicating one or more reserved resources. Additionally, processor 622 may determine a disposition with respect to the first assistance information. Moreover, processor 622 may transmit, via transceiver 626, a second SCI carrying second assistance information related to the first assistance information responsive to the disposition being forwarding the first assistance information.

In some implementations, a respective timing offset of each time resource of the one or more reserved resources as indicated in the second SCI may be different than that indicated in the first SCI.

In some implementations, in transmitting the second SCI, processor 622 may transmit the second SCI carrying the second assistance information indicating one or more resources identical to the one or more reserved resources indicated in the first assistance information carried in the first SCI responsive to a timing of transmission of the second SCI being earlier than a timing of each of the one or more reserved resources.

In some implementations, in transmitting the second SCI, processor 622 may transmit the second SCI carrying the second assistance information indicating at least a first one but not at least a second one of the one or more reserved resources indicated in the first assistance information carried in the first SCI responsive to a timing of transmission of the second SCI being earlier than a timing of the first one of the one or more reserved resources but later than a timing of the second one of the one or more reserved resources.

In some implementations, each of a first source ID and a first destination ID carried in the first SCI may be identical to or different from a second source ID or a second destination ID carried in the second SCI, respectively. In some implementations, the first source ID may indicate a first UE (e.g., UE1), the first destination ID may indicate a second UE (e.g., UE2), the second source ID may indicate the first UE, and the second destination ID may indicate a third UE (e.g., UE3) which is an intended receiver of the second SCI.

In some implementations, the first SCI may further carry an indicator, a source ID, and a destination ID. In some implementations, the indicator may be set to indicate that a first UE (e.g., UE1), which transmits the first SCI, supports an assistance information mechanism. Moreover, the source ID may indicate a source of the first assistance information. Additionally, the destination ID may indicate a destination of the first assistance information.

In some implementations, the second SCI may further carry an indicator, a source ID, and a destination ID. In some implementations, the indicator may be set to indicate that a second UE (e.g., UE2), which receives the first SCI, supports an assistance information mechanism. Additionally, the source ID may indicate a source of the first assistance information. Furthermore, the destination ID may indicate a destination of the second assistance information.

In some implementations, processor 622 may perform additional operations. For instance, processor 622 may cancel a transmission of the second SCI responsive to the disposition being cancelling forwarding of the first assistance information due to a timing of each time resource of the one or more reserved resources being earlier than the transmission of the second SCI. Alternatively, processor 622 may disregard the first SCI responsive to the disposition being ignoring the first SCI due to a source ID carried in the first SCI indicating an ID of a UE (e.g., apparatus 620 as UE2 itself) that receives the first SCI.

Under another proposed scheme pertaining to SL resource allocation enhancements in NR V2X communications in accordance with the present disclosure, processor 622 of apparatus 620 may receive, via transceiver 626 and from a first UE (e.g., apparatus 610 as UE1), a first SCI carrying first resource reservation information indicating one or more reserved as being reserved. Moreover, processor 622 may receive, via transceiver 626 and from the first UE, a cancellation SCI carrying information of at least one of the one or more reserved resources. Furthermore, processor 622 may mark the at least one of the one or more reserved resources as being available for utilization.

In some implementations, the cancellation SCI may be either in a new format with a format indicator or in a same format as that of the first SCI with a cancellation indicator. In some implementations, the format indicator or the cancellation indicator may indicate that the cancellation SCI carries information on one or more resources for which reservation is cancelled.

In some implementations, the first resource reservation information in the first SCI may be carried in a resource reservation field of the first SCI. Moreover, the information of the at least one of the one or more reserved resources in the cancellation SCI may be also carried in a resource reservation field of the cancellation SCI.

In some implementations, in receiving the cancellation SCI, processor 622 may receive the cancellation SCI on the at least one of the one or more reserved resources.

In some implementations, processor 622 may perform additional operations. For instance, processor 622 may receive, via transceiver 626 and from a second UE (e.g., UE3), a second SCI carrying second resource reservation information indicating the one or more reserved resources as being reserved. Moreover, processor 622 may compare a first source ID in the first SCI and a second source ID in the second SCI with a list of stored UE IDs to identify a first UE ID associated with the first UE. Furthermore, processor 622 may remove a sensing result corresponding to the first UE ID.

Under another proposed scheme pertaining to SL resource allocation enhancements in NR V2X communications in accordance with the present disclosure, processor 622 of apparatus 620 may receive, via transceiver 626, a pattern of Tx or Rx via an SL from a UE. Additionally, processor 622 may determine whether to follow the received pattern or to combine the received pattern with one or more existing Tx/Rx patterns. Furthermore, processor 622 may perform, via transceiver 626, Tx and Rx when DRX is in effect based on a result of the determining.

In some implementations, in determining, processor 622 may perform certain operations. For instance, processor 622 may compare a priority associated with the received pattern with a respective priority associated with each of the one or more existing Tx/Rx patterns. Based on a result of the comparing, processor 622 may determine to follow the received pattern responsive to the priority associated with the received pattern being higher than the respective priority associated with each of the one or more existing Tx/Rx patterns. Alternatively, processor 622 may determine to combine the received pattern with at least one of the one or more existing Tx/Rx patterns responsive to the priority associated with the received pattern being lower than the respective priority associated with the at least one of the one or more existing Tx/Rx patterns.

In some implementations, in determining, processor 622 may determine based on priorities associated with the received pattern and the one or more existing Tx/Rx patterns that are configured or pre-configured per link pair, per UE, per Tx/Rx pattern, or per packet priority as indicated in SCI.

In some implementations, in determining, processor 622 may determine based on an existing Rx pattern of the one or more existing Tx/Rx patterns.

In some implementations, processor 622 may perform additional operations. For instance, processor 622 may transmit, via transceiver 626, an indication of the one or more existing Tx/Rx patterns in a broadcast or unicast to one or more other UEs.

### Illustrative Processes

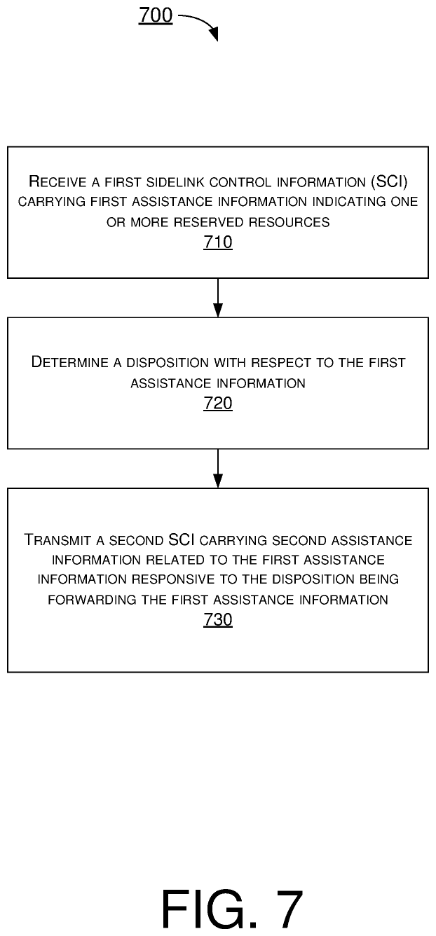

FIG. 7 illustrates an example process 700 in accordance with an implementation of the present disclosure. Process 700 may be an example implementation of the proposed schemes described above with respect to SL resource allocation enhancements in NR V2X communications in accordance with the present disclosure. Process 700 may represent an aspect of implementation of features of apparatus 610 and apparatus 620. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 610, apparatus 620 and/or any suitable wireless communication device, UE, roadside unit (RUS), base station or machine type devices. Solely for illustrative purposes and without limitation, process 700 is described below in the context of apparatus 610 as a first UE (e.g., UE1 in network environment 100) and apparatus 620 as a second UE (e.g., UE2 in network environment 100). Process 700 may begin at block 710.

At block 710, process 700 may involve processor 622 of apparatus 620 receiving, via transceiver 626, a first SCI carrying first assistance information indicating one or more reserved resources. Process 700 may proceed from block 710 to block 720.

At block 720, process 700 may involve processor 622 determining a disposition with respect to the first assistance information. Process 700 may proceed from block 720 to block 730.

At block 730, process 700 may involve processor 622 transmitting, via transceiver 626, a second SCI carrying second assistance information related to the first assistance information responsive to the disposition with respect to the first assistance information.

In some implementations, a respective timing offset of each time resource of the one or more reserved resources as indicated in the second SCI may be different than that indicated in the first SCI.

In some implementations, in transmitting the second SCI, process 700 may involve processor 622 transmitting the second SCI carrying the second assistance information indicating one or more resources identical to the one or more reserved resources indicated in the first assistance information carried in the first SCI responsive to a timing of transmission of the second SCI being earlier than a timing of each of the one or more reserved resources.

In some implementations, in transmitting the second SCI, process 700 may involve processor 622 transmitting the second SCI carrying the second assistance information indicating at least a first one but not at least a second one of the one or more reserved resources indicated in the first assistance information carried in the first SCI responsive to a timing of transmission of the second SCI being earlier than a timing of the first one of the one or more reserved resources but later than a timing of the second one of the one or more reserved resources.

In some implementations, each of a first source ID and a first destination ID carried in the first SCI may be identical to or different from a second source ID or a second destination ID carried in the second SCI, respectively. In some implementations, the first source ID may indicate a first UE (e.g., UE1), the first destination ID may indicate a second UE (e.g., UE2), the second source ID may indicate the first UE, and the second destination ID may indicate a third UE (e.g., UE3) which is an intended receiver of the second SCI.

In some implementations, the first SCI may further carry an indicator, a source ID, and a destination ID. In some implementations, the indicator may be set to indicate that a first UE (e.g., UE1), which transmits the first SCI, supports an assistance information mechanism. Moreover, the source ID may indicate a source of the first assistance information. Additionally, the destination ID may indicate a destination of the first assistance information.

In some implementations, the second SCI may further carry an indicator, a source ID, and a destination ID. In some implementations, the indicator may be set to indicate that a second UE (e.g., UE2), which receives the first SCI, supports an assistance information mechanism. Additionally, the source ID may indicate a source of the first assistance information. Furthermore, the destination ID may indicate a destination of the second assistance information.

In some implementations, process 700 may involve processor 622 performing additional operations. For instance, process 700 may involve processor 622 cancelling a transmission of the second SCI responsive to the disposition being cancelling forwarding of the first assistance information due to a timing of each time resource of the one or more reserved resources being earlier than the transmission of the second SCI. Alternatively, process 700 may involve processor 622 disregarding the first SCI responsive to the disposition being ignoring the first SCI due to a source ID carried in the first SCI indicating an ID of a UE (e.g., apparatus 620 as UE2 itself) that receives the first SCI.

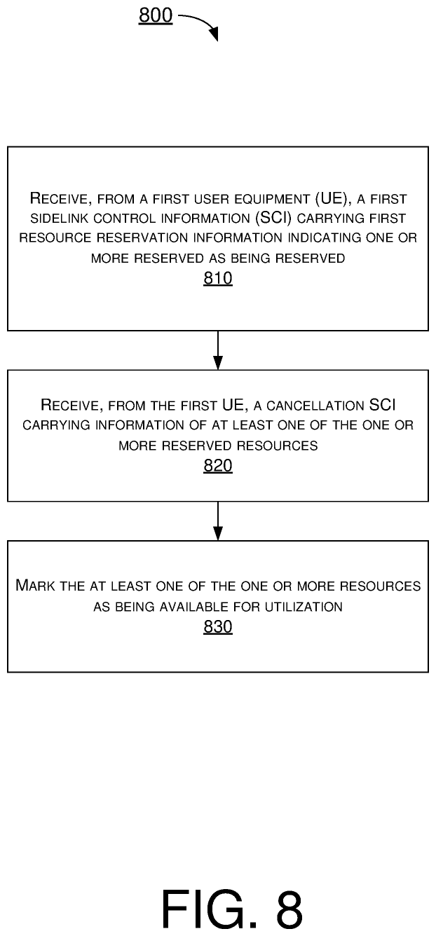

FIG. 8 illustrates an example process 800 in accordance with an implementation of the present disclosure. Process 800 may be an example implementation of the proposed schemes described above with respect to SL resource allocation enhancements in NR V2X communications in accordance with the present disclosure. Process 800 may represent an aspect of implementation of features of apparatus 610 and apparatus 620. Process 800 may include one or more operations, actions, or functions as illustrated by one or more of blocks 810, 820 and 830. Although illustrated as discrete blocks, various blocks of process 800 may be divided into additional blocks, combined into fewer blocks, or eliminated, depending on the desired implementation. Moreover, the blocks of process 800 may executed in the order shown in FIG. 8 or, alternatively, in a different order. Process 800 may also be repeated partially or entirely. Process 800 may be implemented by apparatus 610, apparatus 620 and/or any suitable wireless communication device, UE, RUS, base station or machine type devices. Solely for illustrative purposes and without limitation, process 800 is described below in the context of apparatus 610 as a first UE (e.g., UE1 in network environment 100) and apparatus 620 as a second UE (e.g., UE2 in network environment 100). Process 800 may begin at block 810.

At block 810, process 800 may involve processor 622 of apparatus 620 receiving, via transceiver 626 and from a first UE (e.g., apparatus 610 as UE1), a first SCI carrying first resource reservation information indicating one or more reserved resources as being reserved. Process 800 may proceed from block 810 to block 820.

At block 820, process 800 may involve processor 622 receiving, via transceiver 626 and from the first UE, a cancellation SCI carrying information of at least one of the one or more reserved resources. Process 800 may proceed from block 820 to block 830.

At block 830, process 800 may involve processor 622 marking the at least one of the one or more reserved resources as being available for utilization.

In some implementations, the cancellation SCI may be either in a new format with a format indicator or in a same format as that of the first SCI with a cancellation indicator. In some implementations, the format indicator or the cancellation indicator may indicate that the cancellation SCI carries information on one or more resources for which reservation is cancelled.

In some implementations, the first resource reservation information in the first SCI may be carried in a resource reservation field of the first SCI. Moreover, the information of the at least one of the one or more reserved resources in the cancellation SCI may be also carried in a resource reservation field of the cancellation SCI.

In some implementations, in receiving the cancellation SCI, process 800 may involve processor 622 receiving the cancellation SCI on the at least one of the one or more reserved resources.

In some implementations, process 800 may involve processor 622 performing additional operations. For instance, process 800 may involve processor 622 receiving, via transceiver 626 and from a second UE (e.g., UE3), a second SCI carrying second resource reservation information indicating the one or more reserved as being reserved. Moreover, process 800 may involve processor 622 comparing a first source ID in the first SCI and a second source ID in the second SCI with a list of stored UE IDs to identify a first UE ID associated with the first UE. Furthermore, process 800 may involve processor 622 removing a sensing result corresponding to the first UE ID.

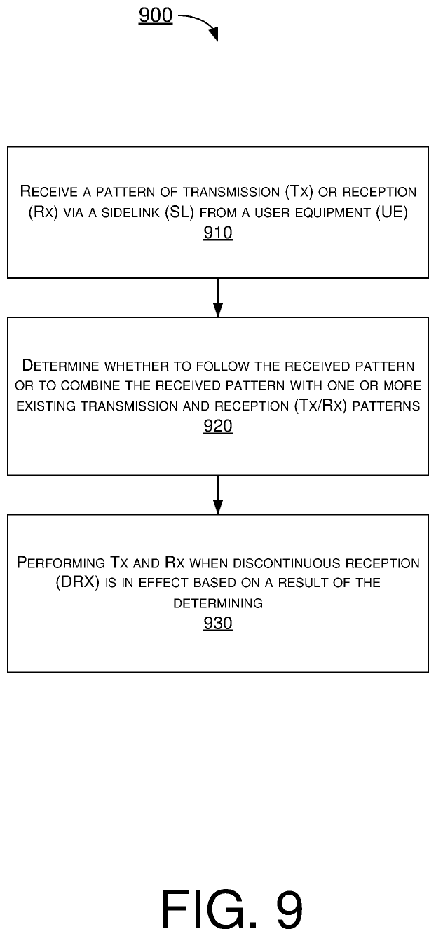

FIG. 9 illustrates an example process 900 in accordance with an implementation of the present disclosure. Process 900 may be an example implementation of the proposed schemes described above with respect to SL resource allocation enhancements in NR V2X communications in accordance with the present disclosure. Process 900 may represent an aspect of implementation of features of apparatus 610 and apparatus 620. Process 900 may include one or more operations, actions, or functions as illustrated by one or more of blocks 910, 920 and 930. Although illustrated as discrete blocks, various blocks of process 900 may be divided into additional blocks, combined into fewer blocks, or eliminated, depending on the desired implementation. Moreover, the blocks of process 900 may executed in the order shown in FIG. 9 or, alternatively, in a different order. Process 900 may also be repeated partially or entirely. Process 900 may be implemented by apparatus 610, apparatus 620 and/or any suitable wireless communication device, UE, RUS, base station or machine type devices. Solely for illustrative purposes and without limitation, process 900 is described below in the context of apparatus 610 as a first UE (e.g., UE1 in network environment 100) and apparatus 620 as a second UE (e.g., UE2 in network environment 100). Process 900 may begin at block 910.

At block 910, process 900 may involve processor 622 of apparatus 620 receiving, via transceiver 626, a pattern of Tx or Rx via an SL from a UE. Process 900 may proceed from block 910 to block 920.

At block 920, process 900 may involve processor 622 determining whether to follow the received pattern or to combine the received pattern with one or more existing transmission and reception (Tx/Rx) patterns. Process 900 may proceed from block 920 to block 930.

At block 930, process 900 may involve processor 622 performing, via transceiver 626, Tx and Rx when DRX is in effect based on a result of the determining.

In some implementations, in determining, process 900 may involve processor 622 performing certain operations. For instance, process 900 may involve processor 622 comparing a priority associated with the received pattern with a respective priority associated with each of the one or more existing Tx/Rx patterns. Based on a result of the comparing, process 900 may involve processor 622 determining to follow the received pattern responsive to the priority associated with the received pattern being higher than the respective priority associated with each of the one or more existing Tx/Rx patterns. Alternatively, process 900 may involve processor 622 determining to combine the received pattern with at least one of the one or more existing Tx/Rx patterns responsive to the priority associated with the received pattern being lower than the respective priority associated with the at least one of the one or more existing Tx/Rx patterns.

In some implementations, in determining, process 900 may involve processor 622 determining based on priorities associated with the received pattern and the one or more existing Tx/Rx patterns that are configured or pre-configured per link pair, per UE, per Tx/Rx pattern, or per packet priority as indicated in SCI.

In some implementations, in determining, process 900 may involve processor 622 determining based on an existing Rx pattern of the one or more existing Tx/Rx patterns.

In some implementations, process 900 may involve processor 622 performing additional operations. For instance, process 900 may involve processor 622 transmitting, via transceiver 626, an indication of the one or more existing Tx/Rx patterns in a broadcast or unicast to one or more other UEs.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving a first sidelink control information (SCI) carrying first assistance information indicating one or more reserved resources;
determining a disposition with respect to the first assistance information; and
transmitting a second SCI carrying second assistance information related to the first assistance information responsive to the disposition with respect to the first assistance information.

2. The method of claim 1, wherein a respective timing offset of each time resource of the one or more reserved resources as indicated in the second SCI is different than that indicated in the first SCI.

3. The method of claim 1, wherein the transmitting of the second SCI comprises transmitting the second SCI carrying the second assistance information indicating one or more resources identical to the one or more reserved resources indicated in the first assistance information carried in the first SCI responsive to a timing of transmission of the second SCI being earlier than a timing of each of the one or more reserved resources.

4. The method of claim 1, wherein the transmitting of the second SCI comprises transmitting the second SCI carrying the second assistance information indicating at least a first one but not at least a second one of the one or more reserved resources indicated in the first assistance information carried in the first SCI responsive to a timing of transmission of the second SCI being earlier than a timing of the first one of the one or more reserved resources but later than a timing of the second one of the one or more reserved resources.

5. The method of claim 1, wherein each of a first source identifier (ID) and a first destination ID carried in the first SCI is identical to or different from a second source ID or a second destination ID carried in the second SCI, respectively.

6. The method of claim 5, wherein the first source ID indicates a first UE, wherein the first destination ID indicates a second UE, wherein the second source ID indicates the first UE, and wherein the second destination ID indicates a third UE which is an intended receiver of the second SCI.

7. The method of claim 1, wherein the first SCI further carries an indicator, a source identifier (ID), and a destination ID, wherein the indicator is set to indicate that a first user equipment (UE), which transmits the first SCI, supports an assistance information mechanism, wherein the source ID indicates a source of the first assistance information, and wherein the destination ID indicates a destination of the first assistance information.

8. The method of claim 1, wherein the second SCI further carries an indicator, a source identifier (ID), and a destination ID, wherein the indicator is set to indicate that a second user equipment (UE), which receives the first SCI, supports an assistance information mechanism, wherein the source ID indicates a source of the first assistance information, and wherein the destination ID indicates a destination of the second assistance information.

9. The method of claim 1, further comprising:
cancelling a transmission of the second SCI responsive to the disposition being cancelling forwarding of the first assistance information due to a timing of each time resource of the one or more reserved resources being earlier than the transmission of the second SCI.

10. The method of claim 1, further comprising:
disregarding the first SCI responsive to the disposition being ignoring the first SCI due to a source identifier (ID) carried in the first SCI indicating an ID of a user equipment (UE) that receives the first SCI.

11. A method, comprising:
receiving, from a first user equipment (UE), a first sidelink control information (SCI) carrying first resource reservation information indicating one or more reserved resources as being reserved;
receiving, from the first UE, a cancellation SCI carrying information of at least one of the one or more reserved resources; and
marking the at least one of the one or more reserved resources as being available for utilization.

12. The method of claim 11, wherein the cancellation SCI either is in a new format with a format indicator or is in a same format as that of the first SCI with a cancellation indicator, and wherein the format indicator or the cancellation indicator indicates that the cancellation SCI carries information on one or more resources for which reservation is cancelled.

13. The method of claim 11, wherein the first resource reservation information in the first SCI is carried in a resource reservation field of the first SCI, and wherein the information of the at least one of the one or more reserved resources in the cancellation SCI is carried in a resource reservation field of the cancellation SCI.

14. The method of claim 11, wherein the receiving of the cancellation SCI comprises receiving the cancellation SCI on the at least one of the one or more reserved resources.

15. The method of claim 11, further comprising:
receiving, from a second UE, a second SCI carrying second resource reservation information indicating the one or more reserved resources as being reserved;
comparing a first source identifier (ID) in the first SCI and a second source ID in the second SCI with a list of stored UE IDs to identify a first UE ID associated with the first UE; and
removing a sensing result corresponding to the first UE ID.

16. A method, comprising:
receiving a pattern of transmission (Tx) or reception (Rx) via a sidelink (SL) from a user equipment (UE);
determining whether to follow the received pattern or to combine the received pattern with one or more existing transmission and reception (Tx/Rx) patterns; and
performing Tx and Rx when discontinuous reception (DRX) is in effect based on a result of the determining.

17. The method of claim 16, wherein the determining comprises:
comparing a priority associated with the received pattern with a respective priority associated with each of the one or more existing Tx/Rx patterns; and
based on a result of the comparing, either:
determining to follow the received pattern responsive to the priority associated with the received pattern being higher than the respective priority associated with each of the one or more existing Tx/Rx patterns; or
determining to combine the received pattern with at least one of the one or more existing Tx/Rx patterns responsive to the priority associated with the received pattern being lower than the respective priority associated with the at least one of the one or more existing Tx/Rx patterns.

18. The method of claim 16, wherein the determining comprises determining based on priorities associated with the received pattern and the one or more existing Tx/Rx patterns that are configured or pre-configured per link pair, per UE, per Tx/Rx pattern, or per packet priority as indicated in sidelink control information (SCI).

19. The method of claim 16, wherein the determining comprises determining based on an existing Rx pattern of the one or more existing Tx/Rx patterns.

20. The method of claim 16, further comprising:
transmitting an indication of the one or more existing Tx/Rx patterns in a broadcast or unicast to one or more other UEs.
